(19) United States
(12) Patent Application Publication
(10) Pub. No.: US 2015/0082563 A1
(43) Pub. Date: Mar. 26, 2015

(54) BEATER FOR DUST-AFFECTED TUBE WALLS

(71) Applicant: THYSSENKRUPP UHDE GMBH, Dortmund (DE)

(72) Inventors: Lothar Semrau, Essen (DE); Guido Langenkamp, Dortmund (DE)

(73) Assignee: THYSSENKRUPP INDUSTRIAL SOLUTIONS AG, Essen (DE)

(21) Appl. No.: 14/386,793

(22) PCT Filed: Mar. 12, 2013
(86) PCT No.: PCT/EP2013/054937

§ 371 Date: Sep. 20, 2014

(30) Foreign Application Priority Data
Mar. 21, 2012 (DE) 102012005804.7

(51) Int. Cl. F28G 7/00; B06B 1/10

(52) U.S. Cl. CPC F28G 7/00; B06B 1/10
USPC 15/104.07; 29/81.15; 165/84

(57) ABSTRACT

Disclosed herein is a device for introducing beating or pulsed movements into tube walls within a pressure vessel, wherein a first ram imparting the beating pulse to the tube wall passes through the pressure vessel wall and is guided into a pressurized first annular space which is acted upon by a second ram, which is guided in a further tubular chamber. Such a device is intended to provide a solution by which the wear of the ram that acts on the tube wall is compensated over as long a time as possible and effective sealing with respect to the surroundings is ensured. This is achieved by the second ram being provided with at least one first guide, acting upon the inner wall of the tubular chamber, in the region of the end of said second ram that makes contact with the first ram and being provided with a second guide, fitted with a sealing element, in the region of the end of said second ram that protrudes from the tubular chamber, and by the second ram being enclosed between the two guides by a gas-tightly fixed compensator.

The invention is directed to an apparatus for introducing beating or pulsed movements into tube walls within a pressure vessel, wherein a first ram imparting the beating pulse to the tube wall presses through the pressure vessel wall, guided into a pressurized first annular space which is acted upon by a second ram guided in a further tubular chamber.

There are a number of applications of beaters of this type, in particular for heat exchangers in chemical processes, which are used inside or outside pressure vessels, e.g. in the case of tube walls of the pressure vessel for coal gasification, in which it is attempted to maintain the operation also of the transfer of heat into the tube walls at a high level. Devices of this type for introducing striking pulses into the tube walls in order that the dust can flow off are described, for example, in WO 2010/0637552 A1 or WO 2010/063755 A1.

A pneumatic beater is disclosed in DE 196 52 707 C2, and a beating or striking apparatus on heating boilers is also disclosed in DE 10 2010 007 197 A1, to name just a few examples.

Since, for example, comparatively high pressures arise in the pressure vessels used for the coal gasification and as a result, inter alia, the rams or hammers used for transferring pulses are subjected to wear, not only is it necessary to provide for special sealing of the inner space of the pressure vessel with respect to the surroundings, but rather it is also necessary to make it possible to compensate for the shortening of the hammers or rams caused by the wear. In this respect, the solution according to WO 2010/063755 A1, for example, provides a compression spring acting on the ram in a chamber, this chamber being at a pressure that is slightly higher than the internal pressure of the coal gasifier owing to gas being fed in from outside.

In practice, it has been found that it is entirely possible for springs of this type to fracture. It is also the case that the escape of dust-afflicted synthesis gas is not ensured with absolute certainty.

A slightly different solution with merely one pressure chamber is disclosed by WO 2010/063752 A1, as already mentioned above, in which the striking ram is fastened to the end face of a chamber subjected to pressurized gas.

It is an object of the invention to provide a solution which both compensates for the wear of the hammer or ram acting upon the tube wall over the longest possible time and also ensures effective sealing with respect to the surroundings.

With an apparatus of the type mentioned in the introduction, this object is achieved according to the invention in that the second ram is provided with at least one first guide, acting upon the inner wall of the tubular chamber, in the region of the end thereof which makes contact with the first ram, and is provided with a second guide equipped with a sealing element in the region of the end thereof which protrudes from the tubular chamber, and in that the second ram is enclosed between the two guides by a compensator fixed in a gas-tight manner.

The compensator or bellows ensures that no gas can escape from the pressure vessel into the surroundings without the mobility of the ram which transfers the beating or pulsed movements to the tube wall being influenced.

One possible configuration of the invention consists in the fact that the second ram with the compensator is surrounded in the tubular chamber by a compression spring, but a preferred configuration of the invention consists in the fact that the guide of the second ram is provided with seals to form an annular space sealed off with respect to the surroundings, the outwardly facing ram being surrounded by a static seal.

The latter configuration has the advantage that, by way of example, a static seal can have different physical and chemical properties to, for instance, a dynamic seal, which is subjected to abrasion as it moves, for example.

One configuration consists according to the invention in the fact that the seals are formed by O ring seals, which are positioned in the annular disks surrounding the second ram, at least one annular disk being provided with an annular flange facing into the annular space to fix one end of the compensator.

A modified embodiment of the seal consists in the fact that the static seal is positioned between an annular disk surrounding the second ram and the end face of the annular space, the annular disk being provided with an annular flange facing into the annular space to fix one end of the compensator.

In order to prevent dust-laden gas from getting into the surroundings or into the region of seals of the second annular space, it is provided according to the invention that a filter element surrounding the first ram and preventing the passage of dust is provided in the annular space.

One configuration of such an element preventing the passage of dust consists in the fact that the filter element is formed by a sintered metal tube portion positioned between two annular disks, the annular disks tightly enclosing the first ram, whereas the sintered metal tube portion surrounds the first ram at a distance.

One configuration of the filter element consists in the fact that the annular disk facing toward the annular space is provided with recesses on the marginal edge thereof which bears against the first ram, and the second annular disk is provided with recesses on the marginal edge thereof which makes contact with the inner wall of the annular space, it also being possible to provide for the fact that the respective other marginal edge of the annular disks has an O ring seal. This makes it possible to achieve flow through the sintered metal tube portion.

It is expedient to visually identify the change in length of the hammer or of said ram. In this respect, the invention provides that the end of the second ram protruding from the chamber is equipped with an electronic or mechanical device which identifies changes in length, in particular the abrasion of the first ram.

A robust, simple and less interference-prone design of such an element can consist in the fact that the ram end protruding from the chamber is equipped with an indicator, to which an immovable scale is assigned.

The invention is explained in more detail by way of example hereinbelow with reference to the drawing, in which:

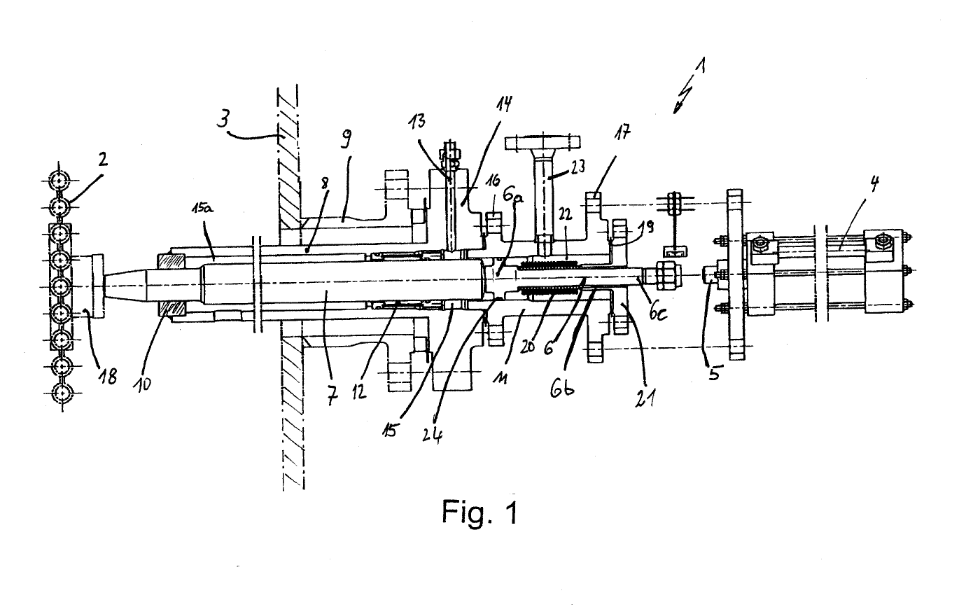

FIG. 1 shows a simplified sectional illustration through an overall view of the apparatus according to the invention,

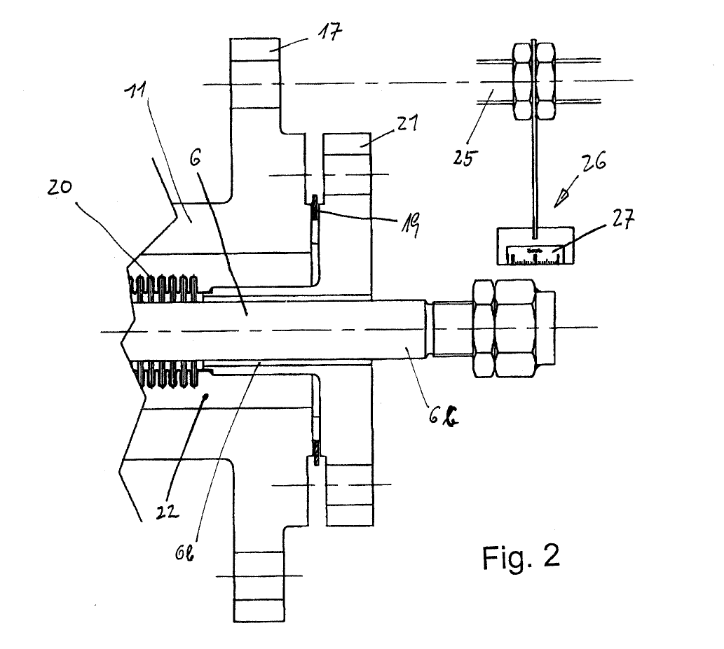

FIGS. 2 to 4 show, in an enlarged sectional illustration, a partial region of three exemplary embodiments, and

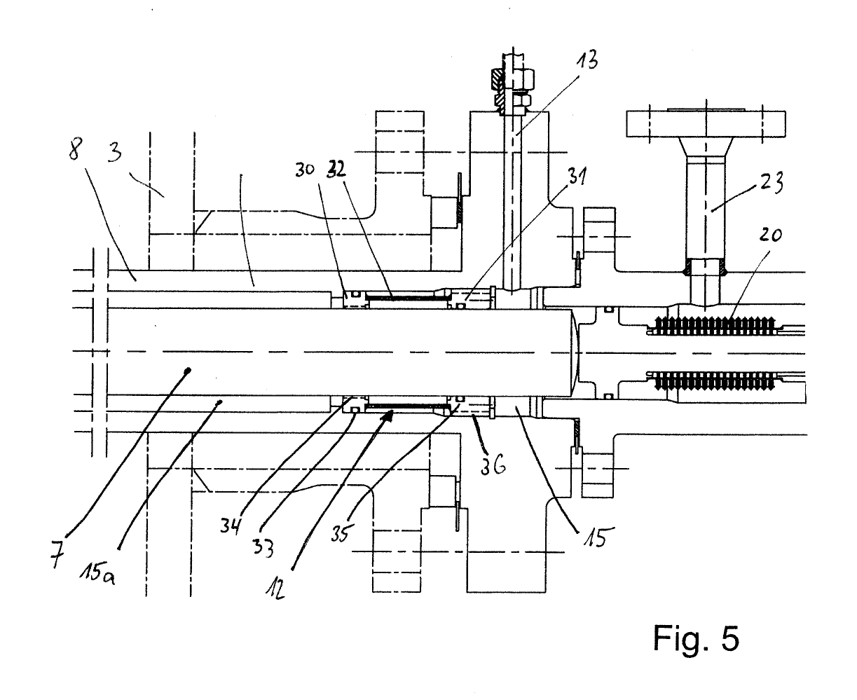

FIG. 5 shows an enlarged illustration of a filter element surrounding the ram or hammer.

The apparatus which is shown in FIG. 1 in a simplified sectional illustration and is denoted in general by 1 serves for applying beating pulses to a tube wall 2, shown in part, in a pressure vessel 3, as is used for example in coal gasification plants.

The apparatus 1 is formed substantially by a beating pulse generator 4 or actuator, which triggers the beating pulses and the for example pneumatically operated impact piston 5 of which transfers pulses via a piston rod 6, referred to hereinbelow as second ram 6, to a hammer, referred to hereinbelow as first ram 7, which presses through the pressure vessel wall 3 and introduces the pulse into the tube wall via, for example, a baffle plate 18, which is fastened to the tube wall. Since the inner space of the pressure vessel 3 is both at a high temperature of approximately 500° C. and also at a high pressure of e.g. 50 bar, the passage of the first ram 7 is guided into the pressure vessel in a substantially gas-tight manner, for which purpose a casing tube 8 is screwed to a tube connection piece 9 welded to the pressure vessel 3.

At the side facing toward the tube wall, the first ram 7 is guided in a guide 10, and with the end thereof which is remote from the tube wall protrudes, already outside the pressure vessel, into the end face of a tubular chamber denoted by 11, in which a piston rod, referred to hereinbelow as second ram 6, is also guided.

A filter element denoted in general by 12 is provided inside the casing tube 8 and is intended to ensure that no fine dust and therefore also the gas transporting the fine material passes to the outside. In addition, provision is made here of a pressurized gas line 13 in the blocking flange 14 of the casing tube 8, in order to build up a pressure which is slightly higher than the internal pressure in the pressure vessel 3 in the annular space 15 between the casing tube 8 and the first ram 7. The blocking flange 14 serves to fasten the casing tube 8 to the tube connection piece 9 and therefore to the pressure vessel 3. In the example shown in FIG. 1, the tubular chamber 11 surrounding the piston rod or the second ram 6 is equipped with two fastening flanges 16 and 17, the fastening flange 16 serving to fasten the tubular chamber 11 to the blocking flange 14, while the fastening flange 17 serves to fasten the beating pulse generator 4 to the tubular chamber 11.

At its end facing toward the first ram 7, the second ram 6, which is guided in the tubular chamber 11, has a guide 6a, which in the example shown in FIG. 1 is formed as a disk in one piece with the second ram 6 and at its end has an O ring seal, with other designs being evident from the following figures. The guide 6a can also be formed by a separate annular disk.

The ram 6 is also held in a guide 6b, the end 6c of the ram protruding from the tubular chamber 11. This second guide 6b is part of a flange element 21 formed as an annular disk, a static seal 19 being provided between the flange element 12 and the fastening flange 17 in the example shown in FIG. 1.

It can also be seen from FIG. 1 that a compensator 20 is fixed between the two guides 6a and 6b in such a manner that the annular space denoted by 22 between the tubular chamber 11 and the second ram is closed off in a gas-tight manner with respect to the surroundings, in the example shown in FIG. 1 in conjunction with the seal 19, by virtue of the compensator being fixed in a pressure-tight manner to the guides 6a and 6b.

In the example shown in FIG. 1, the annular space 22 can be exposed to a pressurized gas by way of a gas feed line 23 in such a manner that the pressure in the annular space 22 acts on the guide 6a and therefore, since the latter is freely movable and sealed off by way of a seal 24 in the tubular chamber 11, presses the second ram 6 onto the first ram 7 in such a manner as to always ensure that the first ram 6 fixedly rests on the second ram 7 upon wear to the ram 7.

An enlarged illustration of the region of the second guide 6b of the second ram 6 in the tubular chamber 11, in particular the region where the ram 6 emerges outward from the chamber, is shown on an enlarged scale in FIG. 2. Part of a rod system, e.g. made up of a plurality of threaded rods 25a, is also clearly shown in said figure, these being used to fix the beating pulse generator 4 to the fastening flange 17. It is shown here that it is possible to arrange a device 26 on one of the threaded rods 25 which makes it possible to visually identify the penetration of the piston rod 6 into the tubular chamber 11 in the event of wear to the first ram 7, e.g. by means of an indicator in combination with a scale 27. A device 26 of this type can also have an electronic configuration or can identify the change in position of the second ram 6 in a different way.

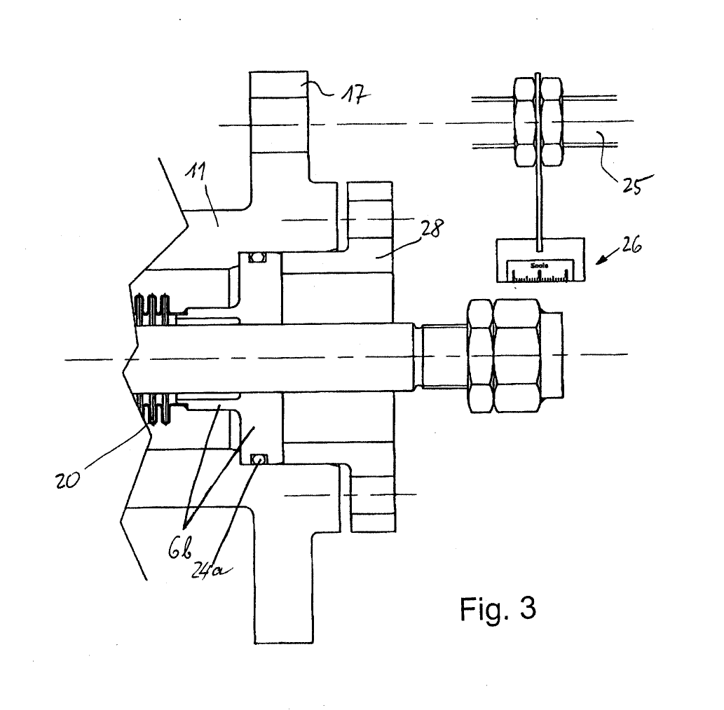

FIG. 3 shows a modified exemplary embodiment. Here, the second guide 6b is part of an annular disk with an outer O ring seal 24a designed as a static seal, the second guide 6b being held by a fixing flange 28 that is screwed to the tubular chamber 11.

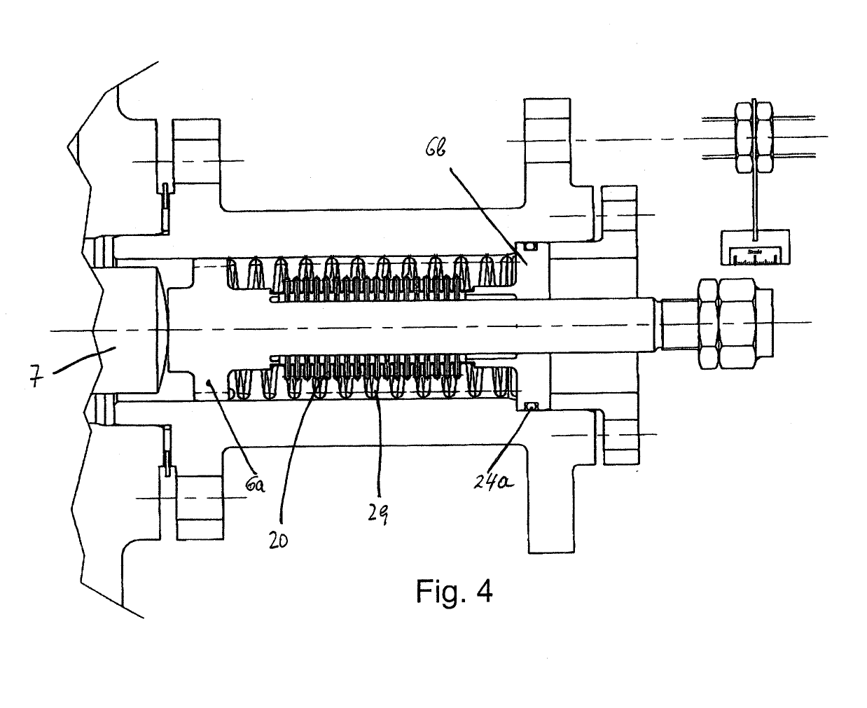

FIG. 4 shows, as a modification to the embodiment shown in FIG. 1, that the compensator 20 is surrounded by a compression spring 29, which is positioned inside the annular space 22 and is supported in a pressure-tight manner on the first guide 6a and the second guide 6b. Since the first guide 6a is mounted displaceably with the second ram 6, the compression spring 29 ensures that the second ram 6 rests permanently on the first ram 7, as can also be seen from FIG. 4.

FIG. 5 shows an enlarged illustration of, inter alia, the filter element 12, which is formed substantially from two annular disks 30 and 31, a sintered metal tube portion 32 being positioned between the two annular disks 30 and 31 at a distance from the first ram 7 and from the casing tube 8. As illustrated by dashed lines, the annular disk 30 has a ring seal 33 bearing against the outside of the casing tube 8, channels or grooves 34 being provided in the end face of the annular disk 30 which bears against the first ram 7.

By contrast, the annular disk 31 has a ring seal, e.g. an O ring 35, to be precise on the end face which bears against the first ram, whereas the end face which faces toward the tube connection piece 8 is equipped with passage grooves 36. It is thereby ensured that gas which is introduced via the line 13 into the annular space 15 at a pressure which is slightly elevated compared to the pressure in the pressure vessel 3 has the possibility can pass through the grooves 36 the sintered metal tube portion 32 and then via the grooves 34 into the annular space 15a between the casing tube 8 and the first ram 7, and therefore is able to prevent a possible flow of gas in the reverse direction from the pressure vessel 3. In the event of a reverse flow, dust particles are deposited on the outer surface of the sintered metal tube portion, and therefore any gas which escapes is free of dust particles.

The described exemplary embodiment of the invention can of course also be modified in a variety of ways without departing from the basic concepts. Thus, the design of a compression spring 29 which may be provided can be different to that shown, the design of the compensator 20 can also differ from the variant shown, and so on.

### LIST OF REFERENCE SIGNS

1 Apparatus

2 Tube wall

3 Pressure vessel

4 Beating pulse generator

5 Impact piston

6 Piston rod, second ram

6a First guide

6b Second guide

6c End

7 First ram, hammer

8 Casing tube

9 Tube connection piece

10 Guide

11 Tubular chamber

12 Filter element

13 Pressurized gas line

14 Blocking flange

15, 15a, 22 Annular space

16, 17 Fastening flange

18 Baffle plate

19, 24 Seal

20 Compensator

21 Flange element+annular disk

23 Gas feed line

25 Threaded rods

26 Device

27 Scale

28 Flange

29 Compression spring

30, 31 Annular disk

32 Sintered metal tube portion

33, 35 O ring seal

34, 36 Grooves

1-11. (canceled)

12. An apparatus for introducing beating or pulsed movements into tube walls within a pressure vessel, comprising:
a first ram slidably guided through an opening defined in an outer wall of the pressure vessel and having a distal end configured to impart a force to the tube walls and a proximal end opposite the distal end, the opening and an outer surface of the first ram defining a pressurized first annular space disposed there between, said first ram being configured to impart a beating pulse to the tube walls disposed within the pressure vessel;
a tubular chamber coupled at a distal end thereof to said opening defined in the outer wall of the pressure vessel;
a second ram disposed at least partially within said tubular chamber and having a distal end, a proximal end that protrudes from a proximal end of said tubular chamber, a first guide disposed at said distal end of said second ram that includes a first seal coupled thereto and is slidably and sealingly in contact with an inner wall of said tubular chamber, a second guide disposed between said distal and proximal ends of said second ram that includes a second seal disposed proximal from said first guide of said second ram, wherein said respective first and second seals of said first and second guides together with an inner surface of said tubular chamber define a sealed annular space within said tubular chamber, wherein said proximal end of said second ram is further surrounded by a static seal, said second ram being configured to impart a beating pulse at said distal end to a proximal end of said first ram; and
a gas-tightly affixed compensator enclosing a region of said second ram disposed between said first guide and said second guide.

13. The apparatus of claim 12, further comprising a compression spring disposed over and surrounding said compensator on said region of said second ram within said tubular chamber.

14. The apparatus of claim 12, wherein the first and second seals are O-rings disposed in annular disks that extend radially outward from portions of the second ram, at least one annular disk being provided with an annular flange facing into the annular space to fix one end of the compensator.

15. The apparatus of claim 12, wherein said static seal is disposed between an annular disk extending radially outward from said second ram and an end face of the annular space, said annular disk being provided with an annular flange facing into the annular space to fix one end of the compensator.

16. The apparatus of claim 12, further comprising a filter element disposed around at least a portion of said first ram in said first annular space and configured to prevent the passage of dust thereby.

17. The apparatus of claim 16, wherein said filter element comprises a sintered metal tube portion disposed between first and a second annular end disk, said annular end disks being tightly disposed against an outer surface of said first ram, and said sintered metal tube portion surrounding said first ram at a distance from said outer surface thereof.

18. The apparatus of claim 17, wherein said first annular end disk of said filter element faces toward said first annular space and includes at least one groove defined in an edge thereof that abuts against an outer surface of said first ram, and wherein said second annular end disk of said filter element at least one groove defined in an edge thereof that abuts against said inner wall of said annular space.

19. The apparatus of claim 18, wherein the respective edges of the annular end disks that are opposite the edges in which the grooves are defined have an O-ring seal disposed therein.

20. The apparatus of claim 12, further comprising an indicator device in communication with said proximal protruding end of said second ram that is configured to identify changes in length of the first ram.

21. The apparatus of claim 20, wherein said indicator includes an immovable scale.
